(19) United States
(12) Patent Application Publication
(10) Pub. No.: US 2004/0093580 A1
(43) Pub. Date: May 13, 2004

(54) System and methodology for mobile e-services

(76) Inventors: Carollyn Carson, Bayonne, NJ (US); Roberto Sanchez, Vallejo, CA (US); Gerald Winsor, San Jose, CA (US); Christopher Peltz, Windsor, CO (US)

Correspondence Address: HEWLETT-PACKARD COMPANY, Intellectual Property Administration, P.O. Box 272400, Fort Collins, CO, 80527-2400, US

(21) Appl. No.: 10/292,200

(22) Filed: Nov. 12, 2002

(51) Int. Cl. G06F 9/44; G06F 15/173; G06F 15/16

(52) U.S. Cl. 717/101; 709/203; 709/224

(57) ABSTRACT

A system and method is disclosed for creating a mobile electronic service (MES).

### CROSS-REFERENCE TO RELATED APPLICATIONS

This application is related to [concurrently filed and] commonly assigned U.S. patent application Ser. No. ______ entitled “A SYSTEM AND METHODOLOGY FOR MOBILE E-SERVICES”, attorney docket number 200207846-1; and [concurrently filed and] commonly assigned U.S. patent application Ser. No. ______ entitled “A TAXONOMY FOR MOBILE E-SERVICES”, attorney docket number 200206272-1, the disclosures of which are hereby incorporated herein by reference.

### BACKGROUND

“Web services” is the term currently used within the software industry to signify functionality or “services” that are accessed over a network such as the Internet or World Wide Web (the “Web”). Such a service operates as follows: the client electronically submits a request and, perhaps, some input data that is transmitted across the network to the service. A client may be another software application, another web service, hardware, and the like. The service receives the transmission and performs some operation. The service may then return a response to the requesting client. The nature of the input data, the operation performed, etc., will depend on what the service is and what it does.

Web services are the infrastructure services or applications that provide some component or functionality to an overall, complete solution delivered via the Internet. For example, a web service may encapsulate or utilize a database. The client may submit a request that a search of the database be performed and a keyword to search for. The web service then searches the database and returns the search result to the requesting client. Web services may be simple, such as a service that returns a stock quote, or complex, such as a service that allows users to make car rental reservations or complete a loan application. Electronic services (e-services) are the complete solution delivered via the Internet that may use several web services. Web- and e-services are proliferating across the Internet driving e-commerce and business-to-business (B2B) commerce.

At present, more and more web- and e-services are being offered on the Web. There is a great rush to develop Web services and make them available to the vast clientele on the Internet. Developers are in constant need of better methods, tools, etc. for developing and implementing Web services. Reducing the time required to fully implement a Web service is a key priority. Additionally, with the increase in mobile access devices, new and existing web- and e-services are desired to be delivered over the mobile access networks. Moreover, as the number of such mobile e-services (MES) grows, it becomes important to provide a means of discovering the appropriate service at any given time and for any given location.

The Universal Description, Discovery and Integration (UDDI) for Web services is an industry initiative to promote the interoperability and adoption of web- and e-services. (See www.UDDI.org). The UDDI includes a global business registry of services available on the Internet. This registry has a standard Application Program Interface (API) and lists Web service providers, the services available and electronic access instructions for those services. The increased complexities of real time personalization in mobile services, which are not typically found in other traditional Internet e-services, extend beyond the existing taxonomy schemes incorporated into UDDI.

### SUMMARY

Embodiments of the present invention are directed to a method for providing a mobile electronic services (MES) comprising the steps of creating said MES, and invoking the MES. The invocation comprises one of executing a predetermined service corresponding to the MES and searching for a compatible service prior to executing the compatible service.

Additional embodiments of the present invention are directed to a system for providing MES comprising a creation model for facilitating development of the MES, an invocation model for executing predetermined ones of the MES according to client selections, and a dynamic execution model for finding compatible ones of the MES prior to execution. The dynamic execution model searches according to client selections.

Further embodiments of the present invention are directed to a system and method for creating a MES comprising the steps of assessing a purpose for the MES, designing the MES according to the assessed purpose, setting up an environment for hosting the MES, developing the MES according to the designing step, testing the developed MES, deploying the MES onto the environment, advertising the MES for consumption, validating the advertising step, and monitoring the deploying MES.

Further embodiments of the present invention are directed to a system for creating a MES comprising means for analyzing a goal for provisioning the MES, means for designing the MES according to the assessed goal, means for preparing a hosting environment for the MES, means for coding the MES according to the designing step, means for testing the coded MES, means for installing the MES onto the hosting environment, means for registering the MES with a registration entity, means for validating the registering step, and means for maintaining the deployed MES.

Further embodiments of the present invention are directed to a system for creating a MES comprising a business analyst for assessing a goal for the MES, an architect for assisting the business analyst and for designing the MES, an administrator for setting up an environment for the MES, an engineer for assisting the administrator and for developing the MES, an operations entity for deploying the MES and for monitoring the deployed MES, and a business developer for registering the MES.

### BRIEF DESCRIPTION OF THE DRAWINGS

Reference is now made to the following figures:

FIG. 1 is a flowchart illustrating a web service development paradigm;

FIG. 2 is a high-level block diagram illustrating an embodiment of a mobile e-services life cycle;

FIG. 3 is a high-level block diagram illustrating an embodiment of the creation model of the MESLC; and

FIG. 4 is a high-level block diagram illustrating the main procedures of an embodiment of the MESLC creation model processes.

### DETAILED DESCRIPTION

A development paradigm or model that addresses the entire lifecycle of mobile e-service (MES) development is described in detail below. This model greatly facilitates the creation and invocation of MES. One embodiment of MES development modeling leverages technology described in a co-pending, commonly assigned patent application entitled, “A METHOD OF DEVELOPING A WEB SERVICE AND MARKETING PRODUCTS OR SERVICES USED IN DEVELOPING A WEB SERVICE,” Ser. No. 10/______, attorney docket number 100200137-1. The web services development life cycle (WSDLC) described in the related application provides a web service development paradigm that may be divided into nine steps or phases that may be performed in various orders to fully implement a web service.

FIG. 1 is a flowchart illustrating the nine phase of Web service development. These phases are illustrated in one order. However, the phases can be performed in many other possible orders under the principles of the aboved-referenced related patent application. The WSDLC may include the following steps: (1) define or obtain public business processes, in step 101, (2) program Web service interface for the public or authorized clients, in step 102, (3) construct business objects and data, in step 103, (4) build the behind-the-firewall workflows, in step 104, (5) map the “public” interfaces, in step 105, (6) package the services, in step 106, (7) display the services, in step 107, (8) advertise the services, in step 108, and (9) monitor the operation of the Web service, in step 109.

The MES Life Cycle (MESLC) is an extension to the WSDLC. Because the MESLC generally targets a specific audience, such as hosts of mobile networks or ecosystems and providers of services to these ecosystems, business considerations as well as technical decisions will be addressed in the life cycles. Due to the complexities involved with MES participants or users and the roles they assume, entities and roles are also defined and discussed.

While the WSDLC is incorporated into the MESLC, the MESLC also provides (1) focus on the mobile operators/service providers within the mobile market or ecosystem; (2) inclusion of the business assessment process; (3) further focus on the design and technology assessment process for the creation and invocation of MES; (4) emphasis on the hosting model for the mobile providers and operators; and (5) emphasis on testing of a web service.

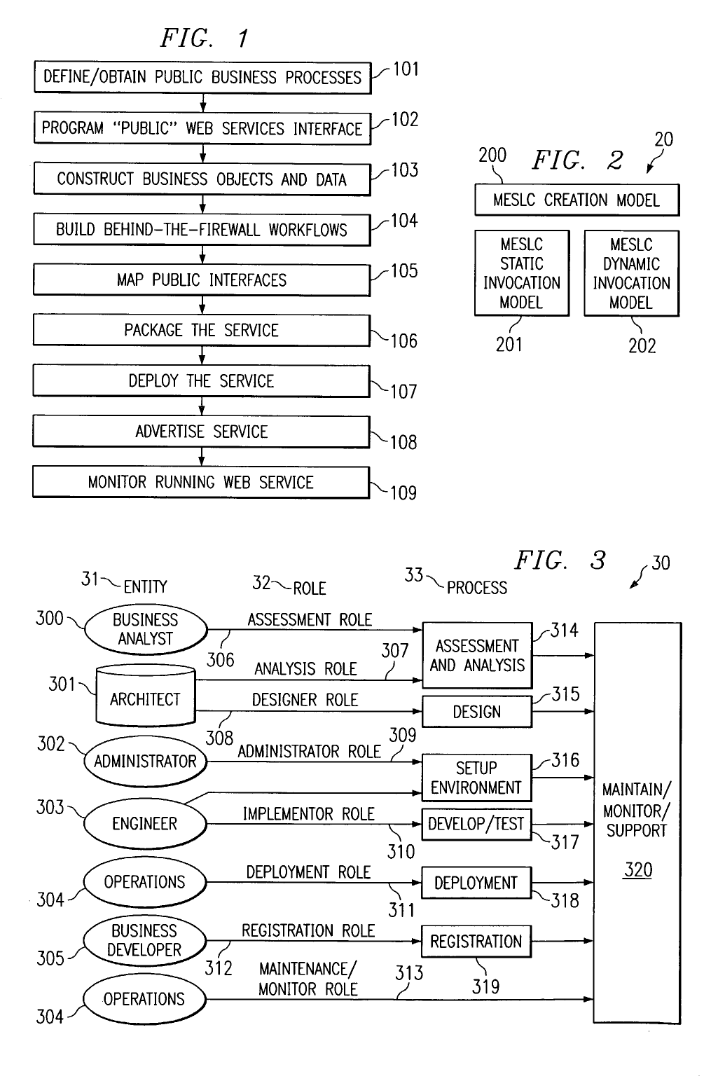

The MESLC offers a MES provisioning model and how it aligns with the MESLC's entity, role, and process definitions. FIG. 2 is a high-level block diagram illustrating one embodiment of a mobile e-services life cycle. MESLC 20 includes three interrelated models. MESLC creation model 200, as described in greater detail below, includes the methodology for creating the MES. The model incorporates both the business and technical assessments as part of the overall MESLC definition and methodology. MESLC static invocation model 201, as disclosed in co-pending, commonly assigned U.S. application Ser. No. ______, attorney docket number 200207846-1, entitled, A METHODOLOGY FOR STATIC INVOCATION OF MOBILE E-SERVICES, involves the invocation of a particular MES for either a static or dynamic workflow. MESLC dynamic invocation model 202 involves the invocation of a e-service searching tool that searches for compatible and desired MES for operation. The major difference between MESLC static invocation model 201 and MESLC dynamic invocation model 202 is that the static invocation has a specific MES bound to the invocation method at design time while the dynamic invocation includes a searching tool that finds the appropriate MES at runtime. MESLC 20 is intended to build upon the WSDLC and will provide additional scope and focus on the mobile industry and services.

The creation model of the MESLC describes entities, roles, and processes for creating a MES. When creating a MES, business and technical considerations need to be in alignment. Considerations such as implementation feasibility, deployment model, taxonomy, and WSDL standards, MES advertising, and binding information should fall under the domain of the business entities. Other considerations such as design, tools, method of development, and functionality testing all reside with the technical entities.

FIG. 3 is a high-level block diagram illustrating an embodiment of a creation model of the MESLC. Creation model 30 includes entities 31, which may be persons or groups, having roles 32 for performing processes 33 that make up the creation process of MES. Business analyst 300 is involved in assessment and analysis process 314 in performing assessment role 306. Business analyst 300 is preferably responsible for determining the business feasibility of the MES. Business feasibility may include analysis of market demand and expected return on investment (ROI), the logistics of hosting and registering the service, and developing any payment models.

Architect 301 preferably is involved with business analyst 300 in assessment and analysis process 314 to perform analysis role 307. Architect 301 may be a person, group, or service who may specialize in web- and e-services and who may provide appropriate insight into the structure and design characteristics of a contemplated MES. Architect 301 is also preferably involved in design process 315 in performing designer role 308. Design process 315 involves the determination and selection of the different types of hardware, languages, and tools to be used in creating and implementing the MES. Architect 301 preferably creates a plan for the development and test environments to ensure the hardware sizing and corresponding software which is to be loaded.

Administrator 302 maybe involved with environment setup process 316 in performing administration role 309. Administrator 302 may create the actual development and test environments with engineer 303. Administrator 302 may also be responsible for the health of the machines, monitoring resources, and providing administrative services to ensure that the development and test teams have access to important functionality, software, and tools. Depending on the size and complexity of the intended project, there may be multiple persons or entities operating as administrator 302, some of which may be provided by a customer. Such administrators 302 may also address issues with legacy systems, backend components, or database interactions with a corporate firewall. In some embodiments, a UDDI administrator may be needed within administrator 302.

In addition to its involvement with administrator 302 in environmental setup process 316, engineer 303 may be involved with develop/test process 317 in performing implementor role 310. As a part of its administrator role 309, engineer 303 may install hardware, hardware components, and set up software, as well as ensure access is given to the environments. In its implementor role 310, engineer 303 may work with tools and create the MES functionality according to the design specifications provided by architect 301.

A tool, which may be running on a computer or computer network, may be used by the service provider to select or define the communication protocol for its service. The tool may be configured to read flow language files (i.e., communication protocol files) from disk and/or write such files to disk. The tool may also have a graphical user interface (GUI); thus, workflow can be represented graphically as a state diagram on the GUI and then represented on disk or in a registry as an extensible markup language (XML) document.

As engineer 303 uses the tool, the service provider may either select an existing communication protocol or can define a new custom communication protocol. The tool may download standard communication protocol files from repositories, such as a UDDI registry, or from a proprietary server. If a standard communication protocol is selected for download, it may be downloaded to the tool via a computer network, such as the Internet.

Examples of existing communication protocols include Hewlett-Packard's Web Services Conversation Language (WSCL) (an XML vocabulary), RosettaNet's Partner Interface Processes (PIPs), Microsoft's XLANG (an XML vocabulary), IBM's Web Services Flow Language, ebXML's XML vocabularies, and also standard XML.

Operations 304 may be involved with deployment process 318 and maintenance, monitoring, and support process 320 for the MES in executing its deployment role 311 and maintenance and monitor role 313. Operations 304 may be responsible for the deployment of the MES to a production environment with the appropriate access through the corporate firewall or hosted environment. Packaged files may be provided by engineer 303 and architect 301, ensuring the appropriate version of the software is made available. Operations 304 may also be responsible for testing the newly deployed MES, as well as monitoring and providing production support.

Business developer 305 may be involved with registration process 319 in executing its registration role 312. Business developer 305 in one embodiment makes the MES advertising decisions. This includes where to register the MES, payment models to be made available, business information registered in UDDI, and the binding information to be provided in a tModel. A tModel is a data structure representing a service type (a generic representation of a registered service) in the UDDI registry. Each business registered with UDDI categorizes all of its web services according to a defined list of service types. Businesses can search the registry's listed service types to find service providers. The tModel is an abstraction for a technical specification of a service type; it organizes the service type's information and makes it accessible in the registry database. Business developer 305 may also supply binding information (i.e., information that supplies an avenue for invoking the web- or e-service), usually in the form of a uniform resource locator (URL), for the tModel in order to allow the MES to be immediately invoked.

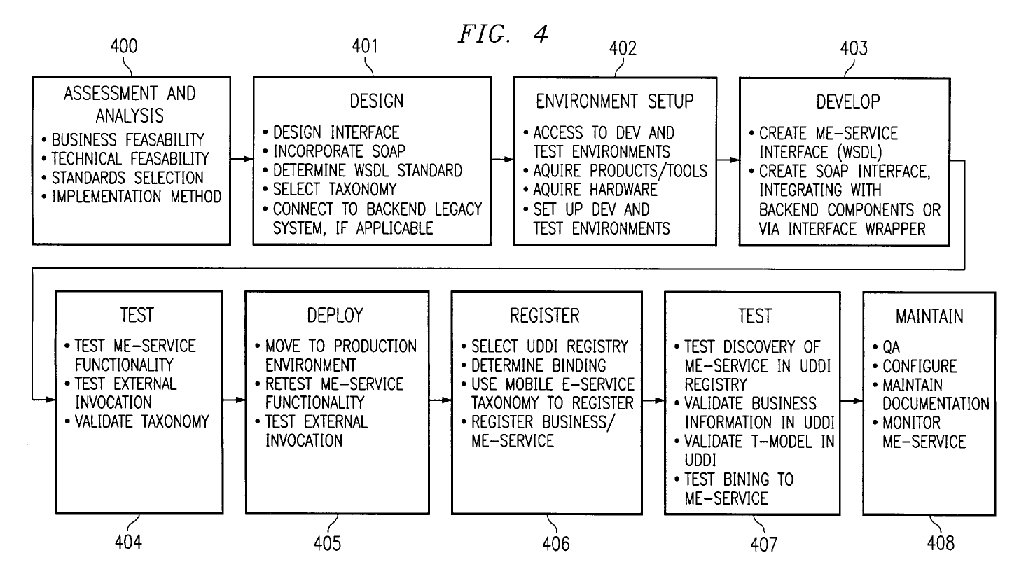

FIG. 4 is a high-level block diagram illustrating the main procedures of an embodiment of the MESLC creation model processes. Assessment and analysis process 400 provides a foundation for decisions that will be made later in the lifecycle. Assessment and Analysis process 400 may include determining business feasibility, analyzing technical feasibility, selecting a taxonomy, deciding upon the interfaces to support, deciding on a hosting and binding model, and determining where to advertise and/or register the MES.

In determining the business feasibility, a provider company may consider the level exposure of the company's intellectual property as a web service accessible by others. Some of the intellectual property may be withheld in order to maintain a competitive edge. Business developer 305 in one embodiment weigh the functionality of the MES against the provider's strategic intellectual property, then determines if the resulting MES is still of value.

The technical feasibility may include analysis of all of the building components. In general, business analyst 300 and architect 301 may determine the general scope of the contemplated system and estimate the amount of work and the types of technology that will be needed to complete the system. In some circumstances, it may also include consideration of the possible incorporation or interface with legacy components that either may or may not be compatible with modem interface systems. Many of the existing tools for developing web- and c-services require Java. Therefore, when incorporating incompatible legacy systems, there will be a need for designing a wrapper with Java for the system.

As a part of the business aspect of designing the web- and/or e-service, consideration may be given to how consumers or clients will actually access or find the service. The selection of a taxonomy plays an important role in making the service accessible. A taxonomy selection may be made that allows for the most visibility for the service. The choice of taxonomies used to advertise a MES may also be driven by the prevalent taxonomy found within the ecosystem that the service would be registered. One taxonomy specifically developed for the intricacies of MES is described in co-pending, commonly assigned patent application entitled, “A TAXONOMY FOR MOBILE E-SERVICES,” Ser. No. 10/______, attorney docket number 200206272-1, incorporated herein for all purposes.

Both classifier and identifier taxonomies may also be taken into consideration. Classifiers are used to categorize the MES allowing for associations to be made to a well-known industry, product, or geography, which can improve the search capabilities within the UDDI registry. Identifiers allow for further identification of the business in the UDDI registry. Some business entity classifiers are usually found in UDDI registries such as North American Industry Classification System (NAICS), Universal Standard Products and Services Classification (UNSPSC), Standard Industrial Classification (SIC). Business identifier taxonomies such as D-U-N-S, from Dun and Bradstreet, and Thomas Registry are also included. Most businesses and services will require additional taxonomies for use as classifiers and identifiers.

The choice of interface is also important in Assessment and Analysis process 300 for providing the maximum exposure for the service. MES may benefit from supporting well-known and accepted interfaces, such as standard interfaces. These interfaces, represented by a WSDL document in UDDI, allow the MES to plug into and interact with hosted ecosystems or walled gardens (i.e., small mobile networks with confined customer participation) that support the interface. In some circumstances, it may be beneficial for a MES to support more than one interface into the same functionality. Similarly, it may be determined that the provider create their own proprietary interface. However, with the use of proprietary components, the adoption of the interface may become an issue.

The determination of the hosting model includes the decision to host the MES from within the provider's firewall or whether it would be hosted remotely. If the provider does not wish to host their MES or expose their internal network to public access, the entire service or even just the wrapper (i.e., the middleware application between the MES and a legacy system) may be hosted remotely.

Binding provides access information for the MES. Typically, either a programmatic interface, such as a URL, is provided, or contact information, such as a name and phone number, may be provided. The determination of the type of binding will drive whether the service is discovered and invoked directly. However, in some embodiments, it may be desirable to qualify a customer before allowing access to the MES. In such situations, it may be beneficial to provide only contact information.

The advertising of a MES determines how consumers and users will discover and implement a MES. A MES may be registered and advertised in a public or private UDDI registry. HP's Universal Business Registry (UBR) is a hosted ecosystem that is accessible for registration and discovery by the public. Private UDDI registries may target industry segments or be hosted by a company for its use. An example of a private registry would generally be one owned and operated by a mobile network operator for the benefit of providing services internally and to its customers.

Design process 401 may be driven from the decisions made in Assessment and Analysis process 400 as well as any MES requirements and/or the incorporation of any legacy elements. Design process 401 includes considerations, such as hardware, design approach, hosting model, granularity of the MES interface, invasiveness, interface, and backend integration and workflow.

Architect 301 generally uses the decisions made with regard to the hosting methods and hardware platform in determining the hardware requirements for the contemplated MES. Some projects may require a separate physical testing environment for at least one of the testing phases. Hardware must, therefore, be planned to provide these testing facilities. Further issues, such as high availability, failure, and growth, may also require analysis for future expandability.

The design approach is generally considered according to the scope of the planned service. When a clearly defined component exists within a legacy system, or a desired data source is already available, a bottom-up design methodology may make sense in order to build up from the known source. In contrast, large projects and new projects are typically designed using a top-down methodology. This approach allows Architect 201 to start with the broad functionality and repeatedly refine it to arrive at specific requirements.

Design process 401 is integrally effected by the selection of hosting models. If the MES is to be hosted remotely, Architect 301 should generally provide platform requirements to the hosting organization. The hosted environment should generally also provide access through its firewall to the Simple Object Access Protocol (SOAP) server. Other options regarding the hosting environment are whether the service may host a complete and independent MES without any backend connections to the owner's infrastructure. In such complete remote hosting instances all executables and components would reside on the host's system.

MES may also be partially-hosted, allowing for components to remain within the corporate firewall, while others are remotely hosted. A partially-hosted MES may have a set of components hosted at both the owner and the host of the MES, with interfaces such as XML/Hypertext Transfer Protocol (http), Transfer Control Protocol (TCP)/Internet Protocol (IP) based ENTERPRISE JAVA BEANS (EJB), messaging, e-mail, and the like. This model is also used when wrappering an existing public interface in a non-invasive approach. A non-invasive approach generally provides that no modifications be made behind the corporate firewall or to the original components.

One issue in design process 401 will be designing the level of access, or the granularity of the MES. A course-grained MES generally may provide a single, simple interface that triggers a complex set of business rules. This provides a simple means to invoke what may be a very complex MES. An example of a course-grained MES may be a photo store. The photo store service would accept digital images from a wireless end-user and allow it to be stored for later retrieval. The digital image may then be e-mailed, sent to a print-shop, or delivered via a multimedia message service (MMS), a multimedia form of short messaging service (SMS).

A fine-grained MES provides a variety of component-based MES interfaces allowing for personalization and control of the service by a consumer. A fine-grained MES may be a collection of MES interfaces which, when combined, may provide a complex service. A consumer, such as a wireless service provider, may find interest in more fine-grained services because the consumer (the service provider) maintains control over subscriber's experience.

The determination of whether the MES will be invasive or non-invasive may play a role in the design of the software. The non-invasive approach typically wrappers an existing public interface, with the wrapper hosted remotely. An invasive approach allows for modifications to the providers components and/or the hosting of additional software within the corporate firewall. The invasive approach generally requires that software be deployed within the infrastructure of the system.

The design of the interface will depend on the communication protocol and interaction model selected. The interface design may generally comprise a remote procedure call (RPC) in which a remote application is called for execution, or a document exchange, in which XML documents are exchanged with the relevant information. The interface is typically designed in accordance with the selected interaction model.

Backend integration and workflow addresses the integration of the logic and data that may become a part of the MES. If the logic already exists, it will be incorporated into the design. Otherwise, design process 301 should account for the creation of new components and provide corresponding design detail. Any interaction and interface issues with legacy systems should be taken into account. For example, legacy components may need integration with other components or may need to be directly extended as a web service. For user-consumable MES, a mobile network will generally be required to deliver the service to the ultimate end user.

Environment setup 402 addresses the hardware, software, and access to be provided in the various environments. For larger projects, architect 301 may provide a plan for the environments used for implementation and testing. Environmental setup 402 includes further consideration of hardware, consideration of the software tools and products, and access methods for providing the MES. Depending on whether the hardware platforms will be hosted locally or accessed remotely, platforms should be acquired and set up according to architect 201 's direction.

Access to remotely hosted environments are typically provided through virtual private network (VPN) software, such as CITRIX, which enables secure application delivery over the Internet. Clients generally load the VPN software for remote connectivity. This technology can also be used when establishing backend connections via TCP/IP to a remote environment, as is the case when using a remotely hosted EJB. Software components for the development of applications should also be installed, such as JAVA SDK or C++ compilers, or .NET framework, and the like.

Hosted environments may also use VPN software to enable remote access. IP addresses should generally be provided by the hosted environment to allow for developer and test access. Furthermore, because MES access will typically occurs behind the firewall, the necessary ports will need to be opened for the application servers hosting the SOAP service.

In develop process 403, whether starting from scratch or web-enabling an existing component, development of MES includes the creation of public interfaces that may be mapped to backend logic (i.e., logic or applications resident on an internal computer system). This logic may comprise other web services, software components, such as EJBs, data interfaces to databases, and workflows.

Vendors have developed tools to simplify some of the tasks required to create web- and e-services. Much of these development tools are targeted to Java, web services, and mobile interface development. Java-based platforms dominate the web service industry. There are a few platforms, tools, and libraries emerging for languages such as C++, ADA, Python, and the like.

Whether creating a MES from scratch or creating one from an existing application, a public web service interface or set of interfaces should typically be created. The MES and its interface may be created from scratch, leveraged from an existing WSDL file, or even created from an existing implementation. In the process of leveraging existing material, Java wrappers are typically used to perform conversion of incompatible formats. A wrapper generally accepts a WSDL-compliant SOAP message and converts it into an interface acceptable to the original component. A reply made by the component is accepted by the wrapper and converted into a WSDL-compliant SOAP message for reply. The wrapper is typically a Java component or EJB, and is also generally used to create WSDL or designed to conform to an existing WSDL. Wrappers are typically used for partial remote hosting, leveraging existing WSDL interfaces, and to use components written in non-Java languages.

In the implementation and development of a MES, it may be composed of other existing MES, web-, or e-services. When incorporating these existing services, the invocation method, workflow, and discovery method should be considered. MES, web-, or e-services used to create a MES should consider whether static or dynamic invocation should be used. The service to use is decided at design time for a static invocation. A dynamic invocation means the service used is determined at runtime. Whether static or dynamic invocation is used, an interface generally needs to be created to these services that conforms to the corresponding WSDL.

The workflow directs which service or services are used and when they are to be used or invoked. Workflow may be a part of the component software or a workflow product may be used.

Part of using the existing service involves discovering the WSDL in a UDDI. Once discovered, a client proxy will generally be created allowing the existing services to be invoked by the new service. These existing services may be discovered in a UDDI repository and the corresponding WSDL extracted. The developer may then create a client proxy to invoke the service, conforming to the interface outlined in the WSDL.

When creating a service from scratch or using existing implementations, the underlying logic behind the MES interface should generally be incorporated. Developers may use integrated development environments (IDEs), text editors, or any other programming tools preferred.

Test process 404 includes the testing of the components to ensure delivery of quality software. The MESLC consists of test phases, which may vary by project based upon the size and complexity of the project. Test process 404 may include a developer's unit test, an integration test, a system test, and an acceptance test. Testing of service components is analogous to the tests performed for other distributed components. The MES functionality, interfaces, external invocation, and adherence to standards should generally be tested.

The unit test is the stand-alone component test phase performed by the developer to ensure correct operation according to requirements resulting from the design phase. This phase of test may require the developer to create stubs, emulating the functionality provided by other components that it will interact with.

Upon successful completion of the unit test, components move to the integration test. This phase tests the interaction of the component with other system components. A MES integration test would test the loosely coupled web service interfaces and interaction with other web services. Any connection to backend components are also tested. If connections are made across a firewall, those will also be tested. Testing is also performed on the integration with front-end components and client proxy software. The delivery system may also be tested by device and gateway simulations. Additionally, the WSDL created by development may also be tested to ensure it appropriately reflects the interface required for interaction with the MES.

Many projects will have a separate organization or engineers tasked with system testing. System test engineers execute the system according to project requirement documents to ensure proper functionality, performance, and quality. Testing is typically outlined in formal test cases and defects are usually reported and tracked. MES that may require connection to remote web services to complete a task generally should have this remote interaction tested during the system test phase. This may require connection to an external web service. In certain cases, use of a live web service my incur costs to the project, and connection to a provider's test site may be desirable, if available.

Most acceptance tests are performed in test environments that are separate from the development environment. This is typically the final testing phase before deployment of the MES to a production environment. Load testing is generally performed to ensure that the system is appropriately configured, tuned, and sized. The acceptance tests should generally be performed with hardware comparable to the production environment with management software installed and running to ensure accurate testing.

Deploy process 405 simply includes the process of deploying the service onto a SOAP server which is, itself, deployed on an application server, such as HP-AS, or any JAVA 2 ENTERPRISE EDITION (J2EE) application server. The service may be deployed onto the SOAP server after successfully completing all phases of testing. Further testing is done when the MES and all of its components have been appropriately deployed by testing the external invocation of the live MES.

Deploying the MES in deploy process 405 only makes the MES available to a customer that can access the MES. Register process 406 includes the steps in advertising the MES so that it can be discovered in the first place. The developer should select a UDDI registry, enter business information, and register the MES. The registration will typically use the taxonomy selected by business analyst 300 and architect 301. The host will determine access to the UDDI registry by providing an interface or requiring information to be provided to an administrator for entry.

The UDDI registry will typically require entry of business information to create a business entity to associate with the service. Prospective customers of the service may then search for a business to find associated web services or make qualification decisions based on this information. Registering a MES generally requires the creation of a business service associated with the business entity. Each business service represents a web service. The business service is registered using a taxonomy, allowing for a categorization of the web service, which can be matched upon by the search filters.

It should be noted that for purposes of the described embodiment of the present invention, it is recommended to use the taxonomy described in co-pending, commonly assigned patent application entitled, “A TAXONOMY FOR MOBILE E-SERVICES,” Ser. No. 10/______, attorney docket number 200206272-1. The binding template may also be created providing a URL or contact information for web service acces. Tmodels, which may contain the technical signature of the service, will generally contain the WSDL associated with the service. Identifiers can be used as an additional means of business identification and qualifications.

Taxonomies for classifiers and identifiers may also need to be addressed. The UDDI registry usually contains a small set of taxonomy structures, including D-U-N-S and Thomas Registry. These taxonomies may not sufficiently identify such businesses as internationally based businesses since they may use other unique identifiers. For example, Finland uses a Finnish trade registration number, which is similar to a D-U-N-S number in the United States. A geographic taxonomy, such as Microsoft's geographic taxonomy, may also be included to describe countries, states, and cities used for further business classification.

Test process 404 tested the MES prior to deployment. Test process 407 ensures that the appropriate information was entered into the UDDI registry for proper MES advertising. It is important to ensure the MES is discoverable by validating all business, contact, binding, and WSDL information. Business developer 305 may test the UDDI registry for discovery of the MES, validation of the business information, validation of the WSDL, and validation of the binding data.

Maintain process 408 is typically an on-going process for monitoring and maintaining the live MES. If the MES is registered into a UDDI registry where the host requires adherence to a service level agreement, Operations 304 should closely monitor the service to ensure the contract service levels are not violated. Maintain process 408 should also include the on-going consideration of configuration and tuning of the MES, maintenance of documentation associated with the MES, monitoring the performance, availability, and usage growth, monitoring the hardware and storage, and monitoring of peripheral service and software, such as an application server, SOAP server, networks, security, and the like. These monitoring and maintenance tasks may include such devices as a help desk and/or controlled access to the system.

What is claimed is:

1. A method for providing a mobile electronic services (MES) comprising the steps of:
creating said MES; and
invoking said MES, wherein said invocation comprises one of:
executing a predetermined service corresponding to said MES; and
searching for a compatible service prior to executing said compatible service.

2 The method of claim 1 wherein said creating step includes:
assessing a purpose for said MES;
designing said MES according to said assessed purpose;
setting up an environment for hosting said MES;
developing said MES according to said designing step;
testing said developed MES;
deploying said MES onto said environment;
advertising said MES for consumption;
validating said advertising step; and
monitoring said deployed MES.

3. A system for providing mobile electronic services (MES) comprising:
a creation model for facilitating development of said MES;
an invocation model for executing predetermined ones of said MES according to client selections; and
a dynamic execution model for finding compatible ones of said MES prior to execution, wherein said dynamic execution model searches according to client selections.

4. The system of claim 3 wherein said creation model includes:
a business analyst for assessing a goal for said MES;
an architect for assisting said business analyst and for designing said MES;
an administrator for setting up an environment for said MES;
an engineer for assisting said administrator and for developing said MES;
an operations entity for deploying said MES and for monitoring said deployed MES; and
a business developer for registering said MES.

5. A method for creating a mobile electronic service (MES) comprising the steps of:
assessing a purpose for said MES;
designing said MES according to said assessed purpose;
setting up an environment for hosting said MES;
developing said MES according to said designing step;
testing said developed MES;
deploying said MES onto said environment;
advertising said MES for consumption;
validating said advertising step; and
monitoring said deployed MES.

6. The method of claim 5 wherein said assessing step includes:
determining a business feasibility;
determining a technical feasibility;
selecting a set of standard for implementing said MES; and
selecting an implementation method for said MES.

7. The method of claim 5 wherein said designing step includes:
designing an interface to said MES;
incorporating an object access protocol;
determining a web service description standard; and
selecting a taxonomy for describing said MES.

8. The method of claim 7 wherein said designing step further includes:
designing a connection for said MES to a back-end system.

9. The method of claim 5 wherein said setting up step includes:
establishing access to a development environment;
establishing access to a testing environment;
acquiring development tools; and
assembling hardware for hosting said MES.

10. The method of claim 5 wherein said developing step includes:
creating a user interface for said MES; and
creating an object access protocol interface.

11. The method of claim 10 wherein said developing step further includes:
integrating a back-end component with said MES.

12. The method of claim 11 wherein said integrating step includes:
interfacing said back-end component with a wrapper application.

13. The method of claim 5 wherein said testing step includes:
testing a functionality of said MES;
testing external invocation of said MES; and
validating a taxonomy describing said MES.

14. The method of claim 5 wherein said deploying step includes:
moving said MES to a production environment;
testing a functionality of said MES; and
testing external invocation of said MES.

15. The method of claim 5 wherein said advertising step includes:
selecting a registration entity;
determining a binding method for said MES;
providing binding data;
using a MES taxonomy to advertise said MES;
entering business information with said registration entity; and
registering said MES with said registration entity.

16. The method of claim 15 wherein said validating step includes:
validating said registering step;
verifying said entered business information; and
testing said provided binding data.

17. The method of claim 5 wherein said monitoring step includes:
monitoring said MES;
monitoring a configuration of said MES; and
maintaining documentation related to said MES.

18. The method of claim 7 wherein said object access protocol comprises Simple Object Access Protocol (SOAP).

19. The method of claim 7 wherein said web service description standard comprises web services description language (WSDL).

20. A system for creating a mobile electronic service (MES) comprising:
means for analyzing a goal for provisioning said MES;
means for designing said MES according to said assessed goal;
means for preparing a hosting environment for said MES;
means for coding said MES according to said designing step;
means for testing said coded MES;
means for installing said MES onto said hosting environment;
means for registering said MES with a registration entity;
means for validating said registering step; and
means for maintaining said deployed MES.

21. The system of claim 20 wherein said means for analyzing includes:
means for determining a business feasibility;
means for determining a technical feasibility;
means for selecting a set of standard for implementing said MES; and
means for selecting an implementation method for said MES.

22. The system of claim 20 wherein said means for designing includes:
means for designing a user interface to said MES;
means for incorporating an object access protocol;
means for determining a web service description standard; and
means for selecting a taxonomy for describing said MES.

23. The system of claim 20 wherein said means for preparing includes:
means for establishing access to a development platform;
means for establishing access to a testing platform;
means for acquiring development applications; and
means for assembling hardware for hosting said MES.

24. The system of claim 20 wherein said means for coding includes:
means for creating a user interface for said MES; and
means for creating an object access protocol interface.

25. The system of claim 20 wherein said means for testing includes:
means for testing a functionality of said MES;
means for testing external invocation of said MES; and
means for validating a taxonomy describing said MES.

26. The system of claim 20 wherein said means for installing includes:
means for disposing said MES to said hosting environment;
means for testing a functionality of said MES; and
means for testing external invocation of said MES.

27. The system of claim 20 wherein said means for registering includes:
means for selecting a registration entity;
means for determining a binding method for said MES;
means for providing binding data;
means for using a MES taxonomy to register said MES; and
means for entering business information with said registration entity.

28. The system of claim 20 wherein said means for maintaining includes:
means for monitoring said MES;
means for monitoring a configuration of said MES; and
means for maintaining documentation related to said MES.

29. A system for creating a mobile electronic service (MES) comprising:
a business analyst for assessing a goal for said MES;
an architect for assisting said business analyst and for designing said MES;
an administrator for setting up an environment for said MES;
an engineer for assisting said administrator and for developing said MES;
an operations entity for deploying said MES and for monitoring said deployed MES; and
a business developer for registering said MES.
